(19) United States
(12) Patent Application Publication
(10) Pub. No.: US 2011/0177444 A1
(43) Pub. Date: Jul. 21, 2011

(54) ADDITIVE PACKAGE FOR TONER

(75) Inventors: Dennis A. Mattison, JR., Marion, NY (US); Chieh-Min Cheng, Rochester, NY (US); Zhen Lai, Webster, NY (US); Christopher D. Blair, Webster, NY (US); Zhaoyang Ou, Webster, NY (US); Philip J. Dale, Hamlin, NY (US)

(73) Assignee: XEROX CORPORATION, Norwalk, CT (US)

(21) Appl. No.: 12/689,429

(22) Filed: Jan. 19, 2010

(51) Int. Cl. G03G 9/08; G03G 5/00

(52) U.S. Cl. 430/108.3; 430/137.21

(57) ABSTRACT

An additive package is provided for use with toners. The additive package may be utilized with ultra low melt toners formed by emulsion aggregation processes. The additive package of the present disclosure provides toners with a low minimum fusing temperature to enable high speed printing. Toners possessing the additive package of the present disclosure also possess wide fusing latitude, good release, high gloss, high blocking temperature, robust particles, excellent triboelectric charge properties, and the like.

### BACKGROUND

The present disclosure relates to processes for producing toners suitable for electrophotographic apparatuses.

Numerous processes are within the purview of those skilled in the art for the preparation of toners. Emulsion aggregation (EA) is one such method. These toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

EA toner processes include coagulating a combination of emulsions, i.e., emulsions including a latex, wax, pigment, and the like, with a flocculent such as polyaluminum chloride and/or aluminum sulfate, to generate a slurry of primary aggregates which then undergoes a controlled aggregation process.

Additives may be included with toner compositions to improve certain characteristics of the toners. For example, additives may promote improved cleaning and transfer performance, adequate charge level and charge stability, as well as minimum sensitivity to relative humidity.

Improved methods for producing toners, as well as additives utilized with such toners, remain desirable. Such processes may reduce production costs for such toners and may be environmentally friendly.

### SUMMARY

The present disclosure provides toners and processes for preparing same. In embodiments, a toner of the present disclosure may include toner particles which include at least one amorphous resin in combination with at least one crystalline resin, an optional colorant, and an optional wax; and a surface additive package including: a polydimethylsiloxane surface treated silica present in an amount of from about 1.15% by weight to about 1.4% by weight of the toner particles; a silazane surface treated silica present in an amount of from about 0.75% by weight to about 0.95%% by weight of the toner particles; a silazane surface treated sol-gel silica present in an amount of from about 0.45% by weight to about 1.5% % by weight of the toner particles; a titania surface treated with a material such as decylsilane, decyltrimethoxysilane and butyltrimethoxysilane present in an amount of from about 0.2% by weight to about 1.0% by weight of the toner particles; a metal oxide such as cerium oxide, tin oxide, and combinations thereof, present in an amount of from about 0.2% by weight to about 0.35% by weight of the toner particles; zinc stearate present in an amount of from about 0.15% by weight to about 0.25% by weight of the toner particles; and a polymethyl methacrylate present in an amount of from about from about 0.4% by weight to about 0.6% by weight of the toner particles.

In other embodiments, a toner of the present disclosure may include toner particles including at least one high molecular weight amorphous resin having a molecular weight of from about 35,000 to about 150,000, in combination with a low molecular weight amorphous resin having a molecular weight of from about 10,000 to about 35,000, in combination with at least one crystalline resin, an optional colorant, and an optional wax, and a surface additive package including: a polydimethylsiloxane surface treated silica present in an amount of from about 1.15% by weight to about 1.4% by weight of the toner particles; a silazane surface treated silica present in an amount of from about 0.75% by weight to about 0.95% by weight of the toner particles; a silazane surface treated sol-gel silica present in an amount of from about 0.45% by weight to about 3.0% by weight of the toner particles; a titania surface treated with a material such as decylsilane, decyltrimethoxysilane and butyltrimethoxysilane present in an amount of from about 0.2% by weight to about 1.2% by weight of the toner particles; a metal oxide such as cerium oxide, tin oxide, and combinations thereof, present in an amount of from about 0.2% by weight to about 0.35% by weight of the toner particles; zinc stearate present in an amount of from about 0.15% by weight to about 0.25% by weight of the toner particles; and a polymethyl methacrylate present in an amount of from about from about 0.4% by weight to about 0.6% by weight of the toner particles.

A method of the present disclosure may include, in embodiments, contacting toner particles with an additive package including: a polydimethylsiloxane surface treated silica present in an amount of from about 1.15% by weight to about 1.4% by weight of the toner particles; a silazane surface treated silica present in an amount of from about 0.75% by weight to about 0.95%% by weight of the toner particles; a silazane surface treated sol-gel silica present in an amount of from about 0.45% by weight to about 3.0% % by weight of the toner particles; a titania surface treated with a material such as decylsilane, decyltrimethoxysilane and butyltrimethoxysilane present in an amount of from about 0.2% by weight to about 1.2% by weight of the toner particles; a metal oxide such as cerium oxide, tin oxide, and combinations thereof, present in an amount of from about 0.2% by weight to about 0.35% by weight of the toner particles; zinc stearate present in an amount of from about 0.15% by weight to about 0.25% by weight of the toner particles; and a polymethyl methacrylate present in an amount of from about from about 0.4% by weight to about 0.6% by weight of the toner particles; and blending the toner particles with the additive package at a rate of from about 500 revolutions per minute to about 2000 revolutions per minute, for a period of time of from about 2 to about 20 minutes.

### BRIEF DESCRIPTION OF THE DRAWINGS

Various embodiments of the present disclosure will be described herein below with reference to the figures wherein:

FIG. 1 is a graph depicting the effects blending parameters may have on the cohesion of an additive package of the present disclosure to toner;

FIG. 2 is a graph depicting the effects blending parameters may have on the charge of toner particles including an additive package of the present disclosure;

FIG. 3A is a scanning electron micrograph of a cyan toner possessing an additive package of the present disclosure;

FIG. 3B is a scanning electron micrograph of a yellow toner possessing an additive package of the present disclosure;

FIG. 3C is a scanning electron micrograph of a magenta toner possessing an additive package of the present disclosure; and

FIG. 3D is a scanning electron micrograph of a black toner possessing an additive package of the present disclosure.

### DETAILED DESCRIPTION

The present disclosure provides additive packages suitable for use in producing toner particles. In embodiments, the additive package contains multiple different additives, the combination of which provide good cleaning and transfer performance, adequate charge level and charge stability, as well as minimum relative humidity (RH) sensitivity. Additional benefits of the proposed formulations also include: reducing photoreceptor wear and deletion; improving A-zone (83° F./85% RH) charge decay; adequately controlling C-zone (50° F./15% RH) filming; and preventing blade damage. The resulting toners produced with an additive package of the present disclosure possess a low minimum fusing temperature (MFT) to enable high speed printing. Toners possessing the additive package of the present disclosure also possess wide fusing latitude, good release, high gloss, high blocking temperature, robust particles, excellent triboelectric charge properties, and the like.

In embodiments, a toner composition of the present disclosure may include at least one low molecular weight amorphous polyester resin, at least one high molecular weight amorphous polyester resin, at least one crystalline polyester resin, at least one wax, and at least one colorant. The at least one low molecular weight amorphous polyester resin may have a weight average molecular weight of from about 10,000 to about 35,000, in embodiments from about 15,000 to about 30,000, and may be present in the toner composition in an amount of about 20 to about 50 weight percent, in embodiments from about 22 to about 45 weight percent. The at least one high molecular weight amorphous polyester resin may have a weight average molecular weight of from about 35,000 to about 150,000, in embodiments from about 45,000 to about 140,000, and may be present in the toner composition in an amount of about 20 to about 50 weight percent, in embodiments from about 22 to about 45 weight percent. The at least one crystalline polyester resin may be present in the toner composition in an amount of 1 to about 15 weight percent, in embodiments from about 3 to about 10 weight percent. The ratio of high molecular weight amorphous resin to low molecular weight amorphous resin to crystalline resin may be from about 6:6:1 to about 5:5:1, in embodiments from about 5.8:5.8:1 to about 5.2:5.2:1. The at least one wax may be present in the toner composition in an amount of 1 to about 15 weight percent, in embodiments from about 3 to about 11 weight percent. The at least one colorant may be present in the toner composition in an amount of 1 to about 18 weight percent, in embodiments from about 3 to about 14 weight percent.

### Resins

Any toner resin may be utilized in the processes of the present disclosure. Such resins, in turn, may be made of any suitable monomer or monomers via any suitable polymerization method. In embodiments, the resin may be prepared by a method other than emulsion polymerization. In further embodiments, the resin may be prepared by condensation polymerization.

The toner composition includes at least one low molecular weight amorphous polyester resin. The low molecular weight amorphous polyester resins, which are available from a number of sources, can possess various melting points of, for example, from about 30° C. to about 120° C., in embodiments from about 75° C. to about 115° C., in embodiments from about 100° C. to about 110° C., and/or in embodiments from about 104° C. to about 108° C. As used herein, the low molecular weight amorphous polyester resin has, for example, a number average molecular weight (Mₙ), as measured by gel permeation chromatography (GPC) of, for example, from about 1,000 to about 10,000, in embodiments from about 2,000 to about 8,000, in embodiments from about 3,000 to about 7,000, and in embodiments from about 4,000 to about 6,000. The weight average molecular weight (M_{w}) of the resin is 50,000 or less, for example, in embodiments from about 2,000 to about 50,000, in embodiments from about 3,000 to about 40,000, in embodiments from about 10,000 to about 30,000, and in embodiments from about 18,000 to about 21,000, as determined by GPC using polystyrene standards. The molecular weight distribution (M_{w}/Mₙ) of the low molecular weight amorphous resin is, for example, from about 2 to about 6, in embodiments from about 3 to about 4. The low molecular weight amorphous polyester resins may have an acid value of from about 8 to about 20 mg KOH/g, in embodiments from about 9 to about 16 mg KOH/g, and in embodiments from about 10 to about 14 mg KOH/g.

Examples of the linear amorphous polyester resins include poly(propoxylated bisphenol A co-fumarate), poly(ethoxylated bisphenol A co-fumarate), poly(butyloxylated bisphenol A co-fumarate), poly(co-propoxylated bisphenol A co-ethoxylated bisphenol A co-fumarate), poly(1,2-propylene fumarate), poly(propoxylated bisphenol A co-maleate), poly(ethoxylated bisphenol A co-maleate), poly(butyloxylated bisphenol A co-maleate), poly(co-propoxylated bisphenol A co-ethoxylated bisphenol A co-maleate), poly(1,2-propylene maleate), poly(propoxylated bisphenol A co-itaconate), poly(ethoxylated bisphenol A co-itaconate), poly(butyloxylated bisphenol A co-itaconate), poly(co-propoxylated bisphenol A co-ethoxylated bisphenol A co-itaconate), poly(1,2-propylene itaconate), and combinations thereof.

In embodiments, a suitable linear amorphous polyester resin may be a poly(propoxylated bisphenol A co-fumarate) resin having the following formula (I):

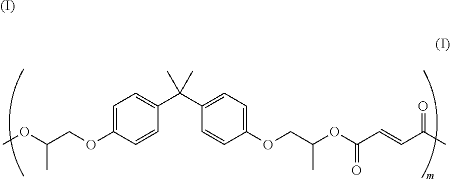

wherein m may be from about 5 to about 1000.

An example of a linear propoxylated bisphenol A fumarate resin which may be utilized as a latex resin is available under the trade name SPARII™ from Resana S/A Industrias Quimicas, Sao Paulo Brazil. Other suitable linear resins include those disclosed in U.S. Pat. Nos. 4,957,774 and 4,533,614, which can be linear polyester resins including terephthalic acid, dodecylsuccinic acid, trimellitic acid, fumaric acid and alkyloxylated bisphenol A, such as, for example, bisphenol-A ethylene oxide adducts and bisphenol-A propylene oxide adducts. Other propoxylated bisphenol A terephthalate resins that may be utilized and are commercially available include GTU-FC115, commercially available from Kao Corporation, Japan, and the like.

In embodiments, the low molecular weight amorphous polyester resin may be a saturated or unsaturated amorphous polyester resin. Illustrative examples of saturated and unsaturated amorphous polyester resins selected for the process and particles of the present disclosure include any of the various amorphous polyesters, such as polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-isophthalate, polypropylene-isophthalate, polybutylene-isophthalate, polypentylene-isophthalate, polyhexalene-isophthalate, polyheptadene-isophthalate, polyoctalene-isophthalate, polyethylene-sebacate, polypropylene sebacate, polybutylene-sebacate, polyethylene-adipate, polypropylene-adipate, polybutylene-adipate, polypentylene-adipate, polyhexalene-adipate, polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate polyethylene-pimelate, polypropylene-pimelate, polybutylene-pimelate, polypentylene-pimelate, polyhexalene-pimelate, polyheptadene-pimelate, poly(ethoxylated bisphenol A-fumarate), poly(ethoxylated bisphenol A-succinate), poly(ethoxylated bisphenol A-adipate), poly(ethoxylated bisphenol A-glutarate), poly(ethoxylated bisphenol A-terephthalate), poly(ethoxylated bisphenol A-isophthalate), poly(ethoxylated bisphenol A-dodecenylsuccinate), poly(propoxylated bisphenol A-fumarate), poly(propoxylated bisphenol A-succinate), poly(propoxylated bisphenol A-adipate), poly(propoxylated bisphenol A-glutarate), poly(propoxylated bisphenol A-terephthalate), poly(propoxylated bisphenol A-isophthalate), poly(propoxylated bisphenol A-dodecenylsuccinate), SPAR (Dixie Chemicals), BECKOSOL (Reichhold Inc), ARAKOTE (Ciba-Geigy Corporation), HETRON (Ashland Chemical), PARAPLEX (Rohm & Haas), POLYLITE (Reichhold Inc), PLASTHALL (Rohm & Haas), CYGAL (American Cyanamide), ARMCO (Armco Composites), ARPOL (Ashland Chemical), CELANEX (Celanese Eng), RYNITE (DuPont), STYPOL (Freeman Chemical Corporation) and combinations thereof. The resins can also be functionalized, such as carboxylated, sulfonated, or the like, and particularly such as sodio sulfonated, if desired.

The low molecular weight amorphous resins, linear or branched, which are available from a number of sources, can possess various onset glass transition temperatures (Tg) of, for example, from about 40° C. to about 80° C., in embodiments from about 50° C. to about 70° C., and in embodiments from about 58° C. to about 62° C., as measured by differential scanning calorimetry (DSC). The linear and branched amorphous polyester resins, in embodiments, may be a saturated or unsaturated resin.

The low molecular weight linear amorphous polyester resins are generally prepared by the polycondensation of an organic diol, a diacid or diester, and a polycondensation catalyst. The low molecular weight amorphous resin is generally present in the toner composition in various suitable amounts, such as from about 60 to about 90 weight percent, in embodiments from about 50 to about 65 weight percent, of the toner or of the solids.

Examples of organic diols selected for the preparation of low molecular weight resins include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol is, for example, selected in an amount of from about 45 to about 50 mole percent of the resin, and the alkali sulfo-aliphatic diol can be selected in an amount of from about 1 to about 10 mole percent of the resin.

Examples of diacid or diesters selected for the preparation of the low molecular weight amorphous polyester include dicarboxylic acids or diesters selected from the group consisting of terephthalic acid, phthalic acid, isophthalic acid, fumaric acid, maleic acid, itaconic acid, succinic acid, succinic anhydride, dodecylsuccinic acid, dodecylsuccinic anhydride, dodecenylsuccinic acid, dodecenylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, dimethyl dodecenylsuccinate, and mixtures thereof. The organic diacid or diester is selected, for example, from about 45 to about 52 mole percent of the resin.

Examples of suitable polycondensation catalyst for either the low molecular weight amorphous polyester resin include tetraalkyl titanates, dialkyltin oxide such as dibutyltin oxide, tetraalkyltin such as dibutyltin dilaurate, dialkyltin oxide hydroxide such as butyltin oxide hydroxide, aluminum alkoxides, alkyl zinc, dialkyl zinc, zinc oxide, stannous oxide, or mixtures thereof; and which catalysts are selected in amounts of, for example, from about 0.01 mole percent to about 5 mole percent based on the starting diacid or diester used to generate the polyester resin.

The low molecular weight amorphous polyester resin may be a branched resin. As used herein, the terms “branched” or “branching” includes branched resin and/or cross-linked resins. Branching agents for use in forming these branched resins include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid, acid anhydrides thereof, and lower alkyl esters thereof, 1 to about 6 carbon atoms; a multivalent polyol such as sorbitol, 1,2,3,6-hexanetetrol, 1,4-sorbitane, pentaerythritol, dipentaerythritol, tripentaerythritol, sucrose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, mixtures thereof, and the like. The branching agent amount selected is, for example, from about 0.1 to about 5 mole percent of the resin.

Linear or branched unsaturated polyesters selected for the in situ pre-wise reactions between both saturated and unsaturated diacids (or anhydrides) and dihydric alcohols (glycols or diols). The resulting unsaturated polyesters are reactive (for example, crosslinkable) on two fronts: (i) unsaturation sites (double bonds) along the polyester chain, and (ii) functional groups such as carboxyl, hydroxy, and the like groups amenable to acid-base reactions. Typical unsaturated polyester resins are prepared by melt polycondensation or other polymerization processes using diacids and/or anhydrides and diols.

In embodiments, the low molecular weight amorphous polyester resin or a combination of low molecular weight amorphous resins may have a glass transition temperature of from about 30° C. to about 80° C., in embodiments from about 35° C. to about 70° C. In further embodiments, the combined amorphous resins may have a melt viscosity of from about 10 to about 1,000,000 Pa*S at about 130° C., in embodiments from about 50 to about 100,000 Pa*S.

The monomers used in making the selected amorphous polyester resin are not limited, and the monomers utilized may include any one or more of, for example, ethylene, propylene, and the like. Known chain transfer agents, for example dodecanethiol or carbon tetrabromide, can be utilized to control the molecular weight properties of the polyester. Any suitable method for forming the amorphous or crystalline polyester from the monomers may be used without restriction.

The amount of the low molecular weight amorphous polyester resin in a toner particle of the present disclosure, whether in core, shell or both, may be present in an amount of from 25 to about 50 percent by weight, in embodiments from about 30 to about 45 percent by weight, and in embodiments from about 35 to about 43 percent by weight, of the toner particles (that is, toner particles exclusive of external additives and water).

In embodiments, the toner composition includes at least one crystalline resin. As used herein, “crystalline” refers to a polyester with a three dimensional order. “Semicrystalline resins” as used herein refers to resins with a crystalline percentage of, for example, from about 10 to about 90%, in embodiments from about 12 to about 70%. Further, as used hereinafter “crystalline polyester resins” and “crystalline resins” encompass both crystalline resins and semicrystalline resins, unless otherwise specified.

In embodiments, the crystalline polyester resin is a saturated crystalline polyester resin or an unsaturated crystalline polyester resin.

The crystalline polyester resins, which are available from a number of sources, may possess various melting points of, for example, from about 30° C. to about 120° C., in embodiments from about 50° C. to about 90° C. The crystalline resins may have, for example, a number average molecular weight (K), as measured by gel permeation chromatography (GPC) of, for example, from about 1,000 to about 50,000, in embodiments from about 2,000 to about 25,000, in embodiments from about 3,000 to about 15,000, and in embodiments from about 6,000 to about 12,000. The weight average molecular weight (M_{w}) of the resin is 50,000 or less, for example, from about 2,000 to about 50,000, in embodiments from about 3,000 to about 40,000, in embodiments from about 10,000 to about 30,000 and in embodiments from about 21,000 to about 24,000, as determined by GPC using polystyrene standards. The molecular weight distribution (M_{w}/Mₙ) of the crystalline resin is, for example, from about 2 to about 6, in embodiments from about 3 to about 4. The crystalline polyester resins may have an acid value of about 2 to about 20 mg KOH/g, in embodiments from about 5 to about 15 mg KOH/g, and in embodiments from about 8 to about 13 mg KOH/g. The acid value (or neutralization number) is the mass of potassium hydroxide (KOH) in milligrams that is required to neutralize one gram of the crystalline polyester resin.

Illustrative examples of crystalline polyester resins may include any of the various crystalline polyesters, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(nonylene-sebacate), poly(decylene-sebacate), poly(undecylene-sebacate), poly(dodecylene-sebacate), poly(ethylene-dodecanedioate), poly(propylene-dodecanedioate), poly(butylene-dodecanedioate), poly(pentylene-dodecanedioate), poly(hexylene-dodecanedioate), poly(octylene-dodecanedioate), poly(nonylene-dodecanedioate), poly(decylene-dodecandioate), poly(undecylene-dodecandioate), poly(dodecylene-dodecandioate), poly(ethylene-fumarate), poly(propylene-fumarate), poly(butylene-fumarate), poly(pentylene-fumarate), poly(hexylene-fumarate), poly(octylene-fumarate), poly(nonylene-fumarate), poly(decylene-fumarate), copoly(5-sulfoisophthaloyl)-copoly(ethylene-adipate), copoly(5-sulfoisophthaloyl)-copoly(propylene-adipate), copoly(5-sulfoisophthaloyl)-copoly(butylene-adipate), copoly(5-sulfo-isophthaloyl)-copoly(pentylene-adipate), copoly(5-sulfo-isophthaloyl)-copoly(hexylene-adipate), copoly(5-sulfo-isophthaloyl)-copoly(octylene-adipate), copoly(5-sulfo-isophthaloyl)-copoly(ethylene-adipate), copoly(5-sulfo-isophthaloyl)-copoly(propylene-adipate), copoly(5-sulfo-isophthaloyl)-copoly(butylene-adipate), copoly(5-sulfo-isophthaloyl)-copoly(pentylene-adipate), copoly(5-sulfo-isophthaloyl)-copoly(hexylene-adipate), copoly(5-sulfo-isophthaloyl)-copoly(octylene-adipate), copoly(5-sulfoisophthaloyl)-copoly(ethylene-succinate), copoly(5-sulfoisophthaloyl)-copoly(propylene-succinate), copoly(5-sulfoisophthaloyl)-copoly(butylene-succinate), copoly(5-sulfoisophthaloyl)-copoly(pentylene-succinate), copoly(5-sulfoisophthaloyl)-copoly(hexylene-succinate), copoly(5-sulfoisophthaloyl)-copoly(octylene-succinate), copoly(5-sulfo-isophthaloyl)-copoly(ethylene-sebacate), copoly(5-sulfo-isophthaloyl)-copoly(propylene-sebacate), copoly(5-sulfo-isophthaloyl)-copoly(butylenes-sebacate), copoly(5-sulfo-isophthaloyl)-copoly(pentylene-sebacate), copoly(5-sulfo-isophthaloyl)-copoly(hexylene-sebacate), copoly(5-sulfo-isophthaloyl)-copoly(octylene-sebacate), copoly(5-sulfo-isophthaloyl)-copoly(ethylene-adipate), copoly(5-sulfo-isophthaloyl)-copoly(propylene-adipate), copoly(5-sulfo-isophthaloyl)-copoly(butylene-adipate), copoly(5-sulfo-isophthaloyl)-copoly(pentylene-adipate), copoly(5-sulfo-isophthaloyl)-copoly(hexylene-adipate) and combinations thereof.

The crystalline resin may be prepared by a polycondensation process by reacting suitable organic diol(s) and suitable organic diacid(s) in the presence of a polycondensation catalyst. Generally, a stoichiometric equimolar ratio of organic diol and organic diacid is utilized, however, in some instances, wherein the boiling point of the organic diol is from about 180° C. to about 230° C., an excess amount of diol can be utilized and removed during the polycondensation process. The amount of catalyst utilized varies, and may be selected in an amount, for example, of from about 0.01 to about 1 mole percent of the resin. Additionally, in place of the organic diacid, an organic diester can also be selected, and where an alcohol byproduct is generated. In further embodiments, the crystalline polyester resin is a poly(dodecandioicacid-co-nonanediol.

Examples of organic diols selected for the preparation of crystalline polyester resins include aliphatic diols with from about 2 to about 36 carbon atoms, such as 1,2-ethanediol, 1,3-propanediol, 1,4-butanediol, 1,5-pentanedial, 1,6-hexanediol, 1,7-heptanediol, 1,8-octanediol, 1,9-nonanediol, 1,10-decanediol, 1,12-dodecanediol, and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol is, for example, selected in an amount of from about 45 to about 50 mole percent of the resin, and the alkali sulfo-aliphatic diol can be selected in an amount of from about 1 to about 10 mole percent of the resin.

Examples of organic diacids or diesters selected for the preparation of the crystalline polyester resins include oxalic acid, succinic acid, glutaric acid, adipic acid, suberic acid, azelaic acid, sebacic acid, phthalic acid, isophthalic acid, terephthalic acid, napthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassium salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbometh-oxybenzene, sulfo-terephthalic acid, dimethyl-sulfo-terephthalate, 5-sulfo-isophthalic acid, dialkyl-sulfo-terephthalate, sulfo-p-hydroxybenzoic acid, N,N-bis(2-hydroxyethyl)-2-amino ethane sulfonate, or mixtures thereof. The organic diacid is selected in an amount of, for example, from about 40 to about 50 mole percent of the resin, and the alkali sulfoaliphatic diacid can be selected in an amount of from about 1 to about 10 mole percent of the resin.

Suitable crystalline polyester resins include those disclosed in U.S. Pat. No. 7,329,476 and U.S. Patent Application Pub. Nos. 2006/0216626, 2008/0107990, 2008/0236446 and 2009/0047593, each of which is hereby incorporated by reference in their entirety. In embodiments, a suitable crystalline resin may include a resin composed of ethylene glycol or nonanediol and a mixture of dodecanedioic acid and fumaric acid co-monomers with the following formula (II):

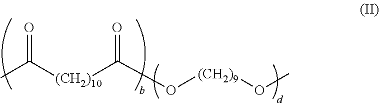

wherein b is from about 5 to about 2000 and d is from about 5 to about 2000.

If semicrystalline polyester resins are employed herein, the semicrystalline resin may include poly(3-methyl-1-butene), poly(hexamethylene carbonate), poly(ethylene-p-carboxy phenoxy-butyrate), poly(ethylene-vinyl acetate), poly(docosyl acrylate), poly(dodecyl acrylate), poly(octadecyl acrylate), poly(octadecyl methacrylate), poly(behenylpolyethoxyethyl methacrylate), poly(ethylene adipate), poly(decamethylene adipate), poly(decamethylene azelaate), poly(hexamethylene oxalate), poly(decamethylene oxalate), poly(ethylene oxide), poly(propylene oxide), poly(butadiene oxide), poly(decamethylene oxide), poly(decamethylene sulfide), poly(decamethylene disulfide), poly(ethylene sebacate), poly(decamethylene sebacate), poly(ethylene suberate), poly(decamethylene succinate), poly(eicosamethylene malonate), poly(ethylene-p-carboxy phenoxy-undecanoate), poly(ethylene dithionesophthalate), poly(methyl ethylene terephthalate), poly(ethylene-p-carboxy phenoxy-valerate), poly(hexamethylene-4,4′-oxydibenzoate), poly(10-hydroxy capric acid), poly(isophthalaldehyde), poly(octamethylene dodecanedioate), poly(dimethyl siloxane), poly(dipropyl siloxane), poly(tetramethylene phenylene diacetate), poly(tetramethylene trithiodicarboxylate), poly(trimethylene dodecane dioate), poly(m-xylene), poly(p-xylylene pimelamide), and combinations thereof.

The amount of the crystalline polyester resin in a toner particle of the present disclosure, whether in core, shell or both, may be present in an amount of from 1 to about 15 percent by weight, in embodiments from about 5 to about 10 percent by weight, and in embodiments from about 6 to about 8 percent by weight, of the toner particles (that is, toner particles exclusive of external additives and water).

As noted above, in embodiments a toner of the present disclosure may also include at least one high molecular weight branched or cross-linked amorphous polyester resin. This high molecular weight resin may include, in embodiments, for example, a branched amorphous resin or amorphous polyester, a cross-linked amorphous resin or amorphous polyester, or mixtures thereof, or a non-cross-linked amorphous polyester resin that has been subjected to cross-linking. In accordance with the present disclosure, from about 1% by weight to about 100% by weight of the high molecular weight amorphous polyester resin may be branched or cross-linked, in embodiments from about 2% by weight to about 50% by weight of the higher molecular weight amorphous polyester resin may be branched or cross-linked.

As used herein, the high molecular weight amorphous polyester resin may have, for example, a number average molecular weight (Mₙ), as measured by gel permeation chromatography (GPC) of, for example, from about 1,000 to about 10,000, in embodiments from about 2,000 to about 9,000, in embodiments from about 3,000 to about 8,000, and in embodiments from about 6,000 to about 7,000. The weight average molecular weight (M_{w}) of the resin is greater than 55,000, for example, from about 55,000 to about 150,000, in embodiments from about 60,000 to about 100,000, in embodiments from about 63,000 to about 94,000, and in embodiments from about 68,000 to about 85,000, as determined by GPC using polystyrene standard. The polydispersity index (PD) is above about 4, such as, for example, greater than about 4, in embodiments from about 4 to about 20, in embodiments from about 5 to about 10, and in embodiments from about 6 to about 8, as measured by GPC versus standard polystyrene reference resins. The PD index is the ratio of the weight-average molecular weight (M_{w}) and the number-average molecular weight (Mₙ). low molecular weight amorphous polyester resins may have an acid value of from about 8 to about 20 mg KOH/g, in embodiments from about 9 to about 16 mg KOH/g, and in embodiments from about 11 to about 15 mg KOH/g. The high molecular weight amorphous polyester resins, which are available from a number of sources, can possess various melting points of, for example, from about 30° C. to about 140° C., in embodiments from about 75° C. to about 130° C., in embodiments from about 100° C. to about 125° C., and in embodiments from about 115° C. to about 121° C.

The high molecular weight amorphous resins, which are available from a number of sources, can possess various onset glass transition temperatures (Tg) of, for example, from about 40° C. to about 80° C., in embodiments from about 50° C. to about 70° C., and in embodiments from about 54° C. to about 68° C., as measured by differential scanning calorimetry (DSC). The linear and branched amorphous polyester resins, in embodiments, may be a saturated or unsaturated resin.

The high molecular weight amorphous polyester resins may prepared by branching or cross-linking linear polyester resins. Branching agents can be utilized, such as trifunctional or multifunctional monomers, which agents usually increase the molecular weight and polydispersity of the polyester. Suitable branching agents include glycerol, trimethylol ethane, trimethylol propane, pentaerythritol, sorbitol, diglycerol, trimellitic acid, trimellitic anhydride, pyromellitic acid, pyromellitic anhydride, 1,2,4-cyclohexanetricarboxylic acid, 2,5,7-naphthalenetricarboxylic acid, 1,2,4-butanetricarboxylic acid, combinations thereof, and the like. These branching agents can be utilized in effective amounts of from about 0.1 mole percent to about 20 mole percent based on the starting diacid or diester used to make the resin.

Compositions containing modified polyester resins with a polybasic carboxylic acid which may be utilized in forming high molecular weight polyester resins include those disclosed in U.S. Pat. No. 3,681,106, as well as branched or cross-linked polyesters derived from polyvalent acids or alcohols as illustrated in U.S. Pat. Nos. 4,863,825; 4,863,824; 4,845,006; 5,143,809; 5,057,596; 4,988,794; 4,981,939; 4,980,448; 4,933,252; 4,931,370; 4,917,983 and 4,973,539, the disclosures of each of which are incorporated by reference herein in their entirety.

In embodiments, cross-linked polyesters resins may be made from linear amorphous polyester resins that contain sites of unsaturation that can react under free-radical conditions. Examples of such resins include those disclosed in U.S. Pat. Nos. 5,227,460; 5,376,494; 5,480,756; 5,500,324; 5,601,960; 5,629,121; 5,650,484; 5,750,909; 6,326,119; 6,358,657; 6,359,105; and 6,593,053, the disclosures of each of which are incorporated by reference in their entirety. In embodiments, suitable unsaturated polyester base resins may be prepared from diacids and/or anhydrides such as, for example, maleic anhydride, terephthalic acid, trimelltic acid, fumaric acid, and the like, and combinations thereof, and diols such as, for example, bisphenol-A ethyleneoxide adducts, bisphenol A-propylene oxide adducts, and the like, and combinations thereof. In embodiments, a suitable polyester is poly(propoxylated bisphenol A co-fumaric acid).

In embodiments, a cross-linked branched polyester may be utilized as a high molecular weight amorphous polyester resin. Such polyester resins may be formed from at least two pre-gel compositions including at least one polyol having two or more hydroxyl groups or esters thereof, at least one aliphatic or aromatic polyfunctional acid or ester thereof, or a mixture thereof having at least three functional groups; and optionally at least one long chain aliphatic carboxylic acid or ester thereof, or aromatic monocarboxylic acid or ester thereof, or mixtures thereof. The two components may be reacted to substantial completion in separate reactors to produce, in a first reactor, a first composition including a pre-gel having carboxyl end groups, and in a second reactor, a second composition including a pre-gel having hydroxyl end groups. The two compositions may then be mixed to create a cross-linked branched polyester high molecular weight resin. Examples of such polyesters and methods for their synthesis include those disclosed in U.S. Pat. No. 6,592,913, the disclosure of which is hereby incorporated by reference in its entirety.

In embodiments, the cross-linked branched polyesters for the high molecular weight amorphous polyester resin may include those resulting from the reaction of dimethylterephthalate, 1,3-butanediol, 1,2-propanediol, and pentaerythritol.

Suitable polyols may contain from about 2 to about 100 carbon atoms and have at least two or more hydroxy groups, or esters thereof. Polyols may include glycerol, pentaerythritol, polyglycol, polyglycerol, and the like, or mixtures thereof. The polyol may include a glycerol. Suitable esters of glycerol include glycerol palmitate, glycerol sebacate, glycerol adipate, triacetin tripropionin, and the like. The polyol may be present in an amount of from about 20% to about 30% weight of the reaction mixture, in embodiments, from about 22% to about 26% weight of the reaction mixture.

Aliphatic polyfunctional acids having at least two functional groups may include saturated and unsaturated acids containing from about 2 to about 100 carbon atoms, or esters thereof, in some embodiments, from about 4 to about 20 carbon atoms. Other aliphatic polyfunctional acids include malonic, succinic, tartaric, malic, citric, fumaric, glutaric, adipic, pimelic, sebacic, suberic, azelaic, sebacic, and the like, or mixtures thereof. Other aliphatic polyfunctional acids which may be utilized include dicarboxylic acids containing a C₃ to C₆ cyclic structure and positional isomers thereof, and include cyclohexane dicarboxylic acid, cyclobutane dicarboxylic acid or cyclopropane dicarboxylic acid.

Aromatic polyfunctional acids having at least two functional groups which may be utilized include terephthalic, isophthalic, trimellitic, pyromellitic and naphthalene 1,4-, 2,3-, and 2,6-dicarboxylic acids.

The aliphatic polyfunctional acid or aromatic polyfunctional acid may be present in an amount of from about 40% to about 65% weight of the reaction mixture, in embodiments, from about 44% to about 60% weight of the reaction mixture.

Long chain aliphatic carboxylic acids or aromatic monocarboxylic acids may include those containing from about 12 to about 26 carbon atoms, or esters thereof, in embodiments, from about 14 to about 18 carbon atoms. Long chain aliphatic carboxylic acids may be saturated or unsaturated. Suitable saturated long chain aliphatic carboxylic acids may include lauric, myristic, palmitic, stearic, arachidic, cerotic, and the like, or combinations thereof. Suitable unsaturated long chain aliphatic carboxylic acids may include dodecylenic, palmitoleic, oleic, linoleic, linolenic, erucic, and the like, or combinations thereof. Aromatic monocarboxylic acids may include benzoic, naphthoic, and substituted naphthoic acids. Suitable substituted naphthoic acids may include naphthoic acids substituted with linear or branched alkyl groups containing from about 1 to about 6 carbon atoms such as 1-methyl-2 naphthoic acid and/or 2-isopropyl-1-naphthoic acid. The long chain aliphatic carboxylic acid or aromatic monocarboxylic acids may be present in an amount of from about 0% to about 70% weight of the reaction mixture, in embodiments, of from about 15% to about 30% weight of the reaction mixture.

Additional polyols, ionic species, oligomers, or derivatives thereof, may be used if desired. These additional glycols or polyols may be present in amounts of from about 0% to about 50% weight percent of the reaction mixture. Additional polyols or their derivatives thereof may include propylene glycol, 1,3-butanediol, 1,3-propanediol, 1,4-butanediol, 1,6-hexanediol diethylene glycol, 1,4-cyclohexanediol, 1,4-cyclohexanedimethanol, neopentyl glycol, triacetin, trimethylolpropane, pentaerythritol, cellulose ethers, cellulose esters, such as cellulose acetate, sucrose acetate iso-butyrate and the like.

In embodiments, the high molecular weight resin, for example a branched polyester, may be present on the surface of toner particles of the present disclosure. The high molecular weight resin on the surface of the toner particles may also be particulate in nature, with high molecular weight resin particles having a diameter of from about 100 nanometers to about 300 nanometers, in embodiments from about 110 nanometers to about 150 nanometers.

The amount of high molecular weight amorphous polyester resin in a toner particle of the present disclosure, whether in the core, the shell, or both, may be from about 25% to about 50% by weight of the toner, in embodiments from about 30% to about 45% by weight, in other embodiments or from about 40% to about 43% by weight of the toner (that is, toner particles exclusive of external additives and water).

The ratio of crystalline resin to the low molecular weight amorphous resin to high molecular weight amorphous polyester resin can be in the range from about 1:1:98 to about 98:1:1 to about 1:98:1, in embodiments from about 1:5:5 to about 1:9:9, in embodiments from about 1:6:6 to about 1:8:8.

### Toner

The resin described above may be utilized to form toner compositions. Such toner compositions may include optional colorants, waxes, and other additives. Toners may be formed utilizing any method within the purview of those skilled in the art. The above resins may be utilized to form EA ultra low melt (ULM) toner particles possessing low minimum fixing temperature, wide fusing latitude, good release, high gloss, high blocking temperature, robust particles, excellent triboelectrical properties, and the like. In this regard, lower minimum fixing is defined as having a MFT (minimum fixing temperature) from about 22° C. to about 25° C. lower than current toner designs to enable a high page per minute (ppm) of printing and a reduction of fusing energy. These properties are important as current electrophotographic machines may operate at speeds of 70 ppm and above.

### Surfactants

In embodiments, resins, colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be utilized. The surfactants may be selected from ionic surfactants and nonionic surfactants. Anionic surfactants and cationic surfactants are encompassed by the term “ionic surfactants.” In embodiments, the surfactant may be utilized so that it is present in an amount of from about 0.01% to about 5% by weight of the toner composition, for example from about 0.75% to about 4% by weight of the toner composition, in embodiments from about 1% to about 3% by weight of the toner composition.

Examples of nonionic surfactants that can be utilized include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonyiphenyl ether, dialkylphenoxy poly(ethyleneoxy) ethanol, available from Rhone-Poulenc as IGEPAL CA-210™, IGEPAL CA-520™, IGEPAL CA720™, IGEPAL CO-89O™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC PE/F, in embodiments SYNPERONIC PE/F 108.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT1υ, available from Alkaril Chemical Company, SANIZOL™ (benzalkonium chloride), available from Kao Chemicals, and the like, and mixtures thereof.

### Colorants

As the colorant to be added, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido)phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and optional colorant in forming toner particles. When included, the wax may be present in an amount of, for example, from about 1 weight percent to about 25 weight percent of the toner particles, in embodiments from about 5 weight percent to about 20 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530T™ available from Micro Powder Inc., fluorinated waxes, for example POLYFLUO 190™, POLYFLUO 200™, POLYSILK 190™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Toner Preparation

The toner particles may be prepared by any method within the purview of one skilled in the art. Although embodiments relating to toner particle production are described below with respect to emulsion-aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion-aggregation processes, such as a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 4 to about 5. Additionally, in embodiments, the mixture may be homogenized. If the mixture is homogenized, homogenization may be accomplished by mixing at about 600 to about 4,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in embodiments from about 0.2% to about 5% by weight, in other embodiments from about 0.5% to about 5% by weight, of the resin in the mixture. This provides a sufficient amount of agent for aggregation.

In order to control aggregation and subsequent coalescence of the particles, in embodiments the aggregating agent may be metered into the mixture over time. For example, the agent may be metered into the mixture over a period of from about 5 to about 240 minutes, in embodiments from about 30 to about 200 minutes. The addition of the agent may also be done while the mixture is maintained under stirred conditions, in embodiments from about 50 rpm to about 1,000 rpm, in other embodiments from about 100 rpm to about 500 rpm, and at a temperature that is below the glass transition temperature of the resin as discussed above, in embodiments from about 30° C. to about 90° C., in embodiments from about 35° C. to about 70° C.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in embodiments from about hour 1 to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

### Particles

Once the desired final size of the toner particles is achieved, the pH of the mixture may be adjusted with a base to a value of from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell Resin

In embodiments, after aggregation, but prior to coalescence, a shell may be applied to the aggregated particles.

Resins which may be utilized to form the shell include, but are not limited to, the amorphous resins described above for use in the core. Such an amorphous resin may be a low molecular weight resin, a high molecular weight resin, or combinations thereof. In embodiments, an amorphous resin which may be used to form a shell in accordance with the present disclosure may include an amorphous polyester of formula I above.

In some embodiments, the amorphous resin utilized to form the shell may be crosslinked. For example, crosslinking may be achieved by combining an amorphous resin with a crosslinker, sometimes referred to herein, in embodiments, as an initiator. Examples of suitable crosslinkers include, but are not limited to, for example free radical or thermal initiators such as organic peroxides and azo compounds described above as suitable for forming a gel in the core. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di(2-ethyl hexanoyl peroxy)hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di(benzoyl peroxy)hexane, oo-t-butyl o-(2-ethyl hexyl)mono peroxy carbonate, and oo-t-amyl o-(2-ethyl hexyl)mono peroxy carbonate, alkyl peroxides such as, for example, dicumyl peroxide, 2,5-dimethyl 2,5-di(t-butyl peroxy)hexane, t-butyl cumyl peroxide, α-α-bis(t-butyl peroxy)diisopropyl benzene, di-t-butyl peroxide and 2,5-dimethyl 2,5di(t-butyl peroxy)hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di(t-butyl peroxy)valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2-di(t-butyl peroxy)butane, ethyl 3,3-di(t-butyl peroxy)butyrate and ethyl 3,3-di(t-amyl peroxy)butyrate, and combinations thereof. Examples of suitable azo compounds include 2,2,′-azobis(2,4-dimethylpentane nitrile), azobis-isobutyronitrile, 2,2′-azobis(isobutyronitrile), 2,2′-azobis(2,4-dimethyl valeronitrile), 2,2′-azobis(methyl butyronitrile), 1,1′-azobis(cyano cyclohexane), other similar known compounds, and combinations thereof.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 30° C. to about 95° C., for a period of time of from about 1 minute to about 10 hours, in embodiments from about 5 minutes to about 5 hours, to form a crosslinked polyester resin or polyester gel suitable for use as a shell.

Where utilized, the crosslinker may be present in an amount of from about 0.001% by weight to about 5% by weight of the resin, in embodiments from about 0.01% by weight to about 1% by weight of the resin. The amount of CCA may be reduced in the presence of crosslinker or initiator.

A single polyester resin may be utilized as the shell or, as noted above, in embodiments a first polyester resin may be combined with other resins to form a shell. Multiple resins may be utilized in any suitable amounts. In embodiments, a first amorphous polyester resin, for example a low molecular weight amorphous resin of formula I above, may be present in an amount of from about 20 percent by weight to about 100 percent by weight of the total shell resin, in embodiments from about 30 percent by weight to about 90 percent by weight of the total shell resin. Thus, in embodiments a second resin, in embodiments a high molecular weight amorphous resin, may be present in the shell resin in an amount of from about 0 percent by weight to about 80 percent by weight of the total shell resin, in embodiments from about 10 percent by weight to about 70 percent by weight of the shell resin.

### Coalescence

Following aggregation to the desired particle size and application of an optional shell resin described above, the particles may then be coalesced to the desired final shape, the coalescence being achieved by, for example, heating the mixture to a suitable temperature. This temperature may, in embodiments, be from about 40° C. to about 99° C., in embodiments from about 50° C. to about 95° C. Higher or lower temperatures may be used, it being understood that the temperature is a function of the resins used.

Coalescence may also be carried out with stirring, for example at a speed of from about 50 rpm to about 1,000 rpm, in embodiments from about 100 rpm to about 600 rpm. Coalescence may be accomplished over a period of from about 1 minute to about 24 hours, in embodiments from about 5 minutes to about 10 hours.

After coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

### Additives

In embodiments, the toner particles may also contain other additives, as desired or required. For example, there can be blended with the toner particles external additive particles including flow aid additives, which additives may be present on the surface of the toner particles.

In embodiments, an additive package for addition to toner in accordance with the present disclosure may include a combination of components. A first component which may be utilized in an additive package of the present disclosure may include a silica possessing a surface treatment, in embodiments, a treatment with a siloxane such as polydimethyl siloxane, octamethylcyclo tetrasiloxane, combinations thereof, and the like. Such silicas include, in embodiments, a silica surface treated with polydimethyl siloxane, such as RY50L available from Evonik (Nippon Aerosil). Such silicas may be of a size of from about 5 to about 100 nanometers, in embodiments from about 10 to about 90 nanometers. Such silicas may be present in an additive package in an amount of from about 0.5% by weight to about 2.5% by weight of the additive package, in embodiments from about 0.75% by weight to about 2% by weight of the additive package. The first component of the additive package may thus be present in an amount of from about 1.15% by weight to about 1.4% by weight of the toner particles including such additive package, in embodiments from about 1.2% by weight to about 1.35% by weight of the toner particles.

A second component which may be utilized in an additive package of the present disclosure may include a silica possessing a surface treatment, in embodiments, a treatment with a silazane such as hexamethyldisilazane, cyclic silazane, combinations thereof and the like. Such silicas include, in embodiments, a silica surface treated with hexamethyldisilazane, such as RX50 available from Evonik (Nippon Aerosil). Such silicas may be of a size of from about 5 to about 100 nanometers, in embodiments from about 10 to about 90 nanometers. Such silicas may be present in an additive package in an amount of from about 0.3% by weight to about 2% by weight of the additive package, in embodiments from about 0.5% by weight to about 1.75% by weight of the additive package. The second component of the additive package may thus be present in an amount of from about 0.75% by weight to about 0.95%% by weight of the toner particles including such additive package, in embodiments from about 0.76% by weight to about 0.94% by weight of the toner particles.

A third component which may be utilized in an additive package of the present disclosure may include a sol-gel silica possessing a surface treatment, in embodiments, a treatment with a silazane such as hexamethyldisilazane, cyclic silazane, combinations thereof and the like. Such silicas include, in embodiments, a sol-gel silica surface treated with hexamethyldisilazane which may be utilized includes X24-9163A available from Nisshin Chemical Kogyo. Such sol-gel silicas may be of a size of from about 50 to about 300 nanometers, in embodiments from about 70 to about 250 nanometers. Such sol-gel silicas may be present in an additive package in an amount of from about 0.2% by weight to about 3% by weight of the additive package, in embodiments from about 0.3% by weight to about 2.8% by weight of the additive package. The third component of the additive package may thus be present in an amount of from about from about 0.45% by weight to about 2.5% % by weight of the toner particles including such additive package, in embodiments from about 0.6% by weight to about 2.3% by weight of the toner particles, in embodiments from about 0.7% by weight to about 2.2% by weight of the toner particles.

A fourth component which may be utilized in an additive package of the present disclosure may include a titanium possessing a surface treatment, in embodiments, a treatment with a silane such as decylsilane, decyltrimethoxysilane, butyltrimethoxysiliane, octylsilane, isobutyl-trimethoxysilane, combinations thereof and the like. Such titania include, in embodiments, a titanium surface treated with butyltrimethoxysiliane, such as STT100H, available from Titan Koygo. Such titania may be of a size of from about 10 to about 150 nanometers, in embodiments from about 20 to about 140 nanometers. Such titania may be present in an additive package in an amount of from about 0.1% by weight to about 2% by weight of the additive package, in embodiments from about 0.2% by weight to about 1.9% by weight of the additive package. The fourth component of the additive package may thus be present in an amount of from about 0.2% by weight to about 1.2% by weight of the toner particles including such additive package, in embodiments from about 0.3% by weight to about 1.1% by weight of the toner particles, in embodiments from about 0.35% by weight to about 1.05% by weight of the toner particles including such additive package.

A fifth component which may be utilized in an additive package of the present disclosure may include a metal oxide such as cerium dioxide, tin oxide, combinations thereof and the like. In embodiments, such a metal oxide may include cerium dioxide, such as E10, available from Mitsui Mining & Smelting. Such metal oxides may be present in an additive package in an amount of from about 0.1% by weight to about 1% by weight of the additive package, in embodiments from about 0.15% by weight to about 0.95% by weight of the additive package. The fifth component of the additive package may thus be present in an amount of from about 0.2% by weight to about 0.35% by weight of the toner particles including such additive package, in embodiments from about 0.22% by weight to about 0.33% by weight of the toner particles.

A sixth component which may be utilized in an additive package of the present disclosure may include metal salts and metal salts of fatty acids inclusive of salts such as zinc stearate, calcium stearate, combinations thereof and the like. Such metal salts include a zinc stearate such as ZnFP, commercially available from NOF. Such metal salt may be of a size of from about 0.2 to about 20 microns, in embodiments from about 0.4 to about 18 microns. Such metal salt may be present in an additive package in an amount of from about 0.05% by weight to about 1% by weight of the additive package, in embodiments from about 0.1% by weight to about 0.95% by weight of the additive package. The sixth component of the additive package may thus be present in an amount of from about 0.15% by weight to about 0.25% by weight of the toner particles including such additive package, in embodiments from about 0.17% by weight to about 0.23% by weight of the toner particles.

A seventh component which may be utilized in an additive package of the present disclosure may include a polymer based upon an acrylate, methacrylate, combinations thereof, and the like. Such polymers include poly(methyl methacrylate) (PMMA) polymer particles, including those sold as MP116CF by Soken. Such a polymer may be present in an additive package in an amount of from about 0.1% by weight to about 1.5% by weight of the additive package, in embodiments from about 0.2% by weight to about 1.4% by weight of the additive package. The seventh component of the additive package may thus be present in an amount of from about from about 0.4% by weight to about 0.6% by weight of the toner particles including such additive package, in embodiments from about 0.42% by weight to about 0.58% by weight of the toner particles.

In embodiments, an exemplary additive package of the present disclosure may include the following components:
1. a silica surface treated with polydimethylsiloxane, such as RY50L available from Evonik (Nippon Aerosil);
2. a silica surface treated with hexamethyldisilazane, such as RX50 available from Evonik (Nippon Aerosil);
3. a sol-gel silica surface treated with hexamethyldisilazane, such as X24-9163A available from Nisshin Chemical Kogyo;
4. a titanium surface treated with butyltrimethoxysiliane, such as STT100H available from Titan Koygo;
5. a cerium dioxide, such as E10 available from Mitsui Mining & Smelting;
6. a zinc stearate, such as ZnFP available from NOF; and
7. PMMA polymer particles, such as MP116CF available from Soken.
   Table 1 below summarizes an exemplary additive package of the present disclosure.

TABLE 1
Toner Additives

| | | functional range, | particle size | | |
|---|---|---|---|---|---|
| additive | wt % | wt % | (D50v) | | functions in toner design |
| RY50L | 1.28 | 1.15-1.40 | 40 | nm | enable good transfer, depress hollow character |
| RX50 | 0.86 | 0.76-0.95 | 40 | nm | depress charge decay, enable good transfer |
| X24 | 0.73 | 0.65-1.90 | 93-130 | nm | enable good transfer & better blade cleaning |
| STT100H | 0.88 | 0.44-0.98 | 10-25 | nm | control flow, charging (A/C), charge |
| | | | | | distribution |
| ZnFP | 0.18 | 0.14-0.22 | 4-6 | μm | prevent filming, reduce photoreceptor wear |
| E10 | 0.28 | 0.22-0.33 | 0.5-0.8 | μm | remove the product of discharge |
| MP116CF | 0.50 | 0.40-0.60 | 0.36-0.5 | μm | prevent filming, depress blade damage |

The relative proportions of these additives may be selected to optimize the charging behavior of toner particles including such additives and to provide optimum performance of a toner in an electrophotographic machine. For example, the amounts of the above materials may be optimized as follows:
(1) optimizing the titanium and cerium dioxide content to adequately control C-zone (50° F./15% RH) filming and prevent blade damage, thereby reducing photoreceptor wear and deletion;
(2) using titanium surface treated with butyltrimethoxysiliane to improve A-zone (83° F./85% RH) charge decay; and
(3) introducing lubricants such as zinc stearate and polymer particles to reduce photoreceptor wear and deletion.

The additive package of the present disclosure may be applied simultaneously with the shell resin described above or after application of the shell resin.

In embodiments, the additive package of the present disclosure may be applied by blending with pre-formed toner particles. Such blending may be conducted utilizing blending and mixing devices commercially available and within the purview of those skilled in the art. Such blending and/or mixing may occur at a rate of from about 500 revolutions per minute (rpm) to about 2000 rpm, in embodiments from about 600 rpm to about 1900 rpm, for a period of time of from about 2 to about 20 minutes, in embodiments from about 4 to about 18 minutes.

Thus, in accordance with the present disclosure, blending and/or mixing of the additives with the toner particles may utilize a specific power of from about 60 watts per pound (W/lb) of toner and additives to about 100 W/lb of toner and additives, in embodiments from about 62 W/lb of toner and additives to about 98 W/lb of toner and additives. The specific energy applied in the blending and/or mixing of the additives with the toner particles may be from about 6.7 watt hours per pound (W-h/lb) of toner and additives to about 20 W-h/lb of toner and additives, in embodiments from about 7.2 W-h/lb of toner and additives to about 19W-h/lb of toner and additives. In embodiments, additives may be applied to toner particles by blending with a specific power of about 80 W/lb of toner and additives and a specific energy of about 13.3 W-h/lb of toner and additives.

In embodiments, toners of the present disclosure may be utilized as ultra low melt (ULM) toners. In embodiments, the toner particles including the additive package of the present disclosure may have the following characteristics:

(1) Volume average diameter (also referred to as “volume average particle diameter”) of from about 3 to about 25 μm, in embodiments from about 4 to about 15 μm, in other embodiments from about 5 to about 12 μm.

(2) Number Average Geometric Size Distribution (GSDn) and/or Volume Average Geometric Size Distribution (GSDv) of from about 1.05 to about 1.55, in embodiments from about 1.1 to about 1.4.

(3) Circularity of from about 0.93 to about 1, in embodiments from about 0.95 to about 0.99 (measured with, for example, a Sysmex FPIA 2100 analyzer).

(4) a gloss of from about 20 Gardner Gloss Units (ggu) to about 80 ggu, in embodiments from about 30 ggu to about 70 ggu.

The characteristics of the toner particles may be determined by any suitable technique and apparatus. Volume average particle diameter D₅₀ᵥ, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

Toners produced in accordance with the present disclosure may possess excellent charging characteristics when exposed to extreme relative humidity (RH) conditions. The low-humidity zone (C zone) may be about 10° C./15% RH, while the high humidity zone (A zone) may be about 28° C./85% RH. Toners of the present disclosure may possess A zone charging of from about −3 μC/g to about −60 μC/g, in embodiments from about −4 μC/g to about −50 μC/g, a parent toner charge per mass ratio (Q/M) of from about −3 μC/g to about −60 μC/g, in embodiments from about −4 μC/g to about −50 μC/g, and a final triboelectric charge of from −4 μC/g to about −50 μC/g, in embodiments from about −5 μC/g to about −40 μC/g.

### Developers

The toner particles thus obtained may be formulated into a developer composition. The toner particles may be mixed with carrier particles to achieve a two-component developer composition. The toner concentration in the developer may be from about 1% to about 25% by weight of the total weight of the developer, in embodiments from about 2% to about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrophotographic or xerographic processes, including those disclosed in U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with a xerographic device including a charging component, an imaging component, a photoconductive component, a developing component, a transfer component, and a fusing component. In embodiments, the development component may include a developer prepared by mixing a carrier with a toner composition described herein. The xerographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

Preparation of Low Molecular Weight Amorphous Polyester Resin (Latex A). A dispersion of an amorphous poly(propoxylated bisphenol A-co-fumaric acid) resin latex was prepared via a phase immersion emulsification (PIE) process using the following formulation: 10/5/1/0.1/20 (Resin/methyl ethyl ketone (MEK)/isopropyl alcohol (IPA), ammonia/deionized water. The reactor was heated with a jacket set point of 60° C. A defoamer, TEGO FOAMEX 830 (approximately 700 ppm), was added incrementally to the reactor through a charging port. Once the reactor reached a temperature of about 58° C., vacuum distillation began. After about 36 minutes, the reactor reached a pressure of about 74 mm of Hg. The resin dispersion of Latex A was then quickly distilled, which reduced the temperature of the reactor to about 45° C. The total amount of time to reach the desired amount of residual solvents (<100 ppm) was from about 14 to about 16 hours. After drying, Latex A possessed a Mw of about 19.8 Kpse, Mn of about 4.9 Kpse, a Tm of about 115.7° C. and a Tg of about 59.2° C., with an average particle size, D50, of about 170 nm.

Preparation of High Molecular Weight Amorphous Polyester Resin (Latex B). A resin dispersion of an amorphous poly(propoxylated bisphenol A-co-fumaric acid) resin latex was prepared via a phase immersion emulsification (PIE) process using the following formulation: 10/5/1/0.1/20 (Resin/methyl ethyl ketone (MEK)/isopropyl alcohol (IPA), ammonia/deionized water. The reactor was heated with a jacket set point of 60° C. A defoamer, TEGO FOAMEX 830 (approximately 700 ppm), was added incrementally to the reactor through a charging port. Once the reactor reached a temperature of about 56.4° C., vacuum distillation began. After about 45 minutes, the reactor reached a pressure of about 116 mm of Hg. The resin dispersion of Latex B was then quickly distilled, which reduced the temperature of the reactor to about 44.5° C. The total amount of time to reach the desired amount of residual solvents (<100 ppm) was from about 14 to about 16 hours. After drying, Latex B possessed a Mw of about 93.9 Kpse, a Mn of about 6.3 Kpse, a Tm of about 128.6° C., and a Tg of about 56.1° C., with an average particle size, D50, of about 170 nm.

Preparation Of Crystalline Polyester Resin (Latex C). A ZSK-53 extruder, equipped with a feed hopper and liquid injection ports, was heated to approximately 95° C. and fed a mixture of 0.1 to 5.0 parts sodium hydroxide, about 0.1 to 10 parts of a surfactant, DOWFAX 2A1, and about 100 parts of a crystalline polyester resin (poly(dodecandioicacid-co-nonanediol). Water heated to about 80 to 95° C. was fed into the extruder's first injection port at a feed rate of about 3 to 5 liter/minutes using a diaphragm pump, wherein the mixture began to emulsify. The polyester resin emulsion had a number and volume average particle size of 58 nm and 67 nm, respectively. After drying, the molecular properties of the latex were a Mw of about 23.9 Kpse and a Mn of about 11.1 Kpse, and the polyester latex possessed an average particle size, D50, of about 160 nm.

### Example 2

Toner Preparation. In a 6000 gallon reactor, about 14 parts of Latex A (solids content about 35 weight percent), about 14 parts Latex B (solids content about 35 weight percent), about 4.7 parts Latex C (solids content 30 about weight percent), all from Example 1, were combined with about 5.8 parts IGI polyethylene wax, (solids content 30 weight percent), about 6.7 parts of a cyan pigment, Pigment Blue 15:3 (solids content 17 weight percent), about 0.3 parts DOWFAX™ 2A1 surfactant, an alkyldiphenyloxide disulfonate from the DOW Chemical Company, and 47 parts of deionized water were combined. The pH of the mixture was adjusted to about 3.2 using a 0.3 M solution of nitric acid (HNO₃). Next, 1.0 parts of a 10 weight percent aluminum sulfate (Al₂(SO₄)₃) solution homogenized using a bench homogenizer (Model ULTRA-TURRAX® T50 Basic from IKA) at 2000 RPM was added over a period of 5 minutes. The reactor was then stirred to about 50 RPM and heated to about 48° C. to aggregate the toner particles.

When the size of the toner particles was determined to be about 5.0 μm, a shell was coated on the toner particles. The shell mixture included about 7.6 parts of Latex A, 7.6 parts of Latex B, 0.1 parts of DOWFAX™ 2A1 surfactant and 100 parts of deionized water. After heating the reactor to 50° C., the size of the toner particles was reduced to 5.8 pm and the pH of the solution was adjusted to 5 using a 4% sodium hydroxide solution. The reactor RPM was then decreased to about 45 RPM, followed by the addition of 0.7 parts of ethylenediaminetetraacetic acid (VERSENE 100). After adjusting and holding constant the pH of the toner particle solution to 7.5, the toner particle solution was heated to a coalescence temperature of 85° C. Once the toner particle solution reached the coalescence temperature, the pH was lowered to a value of 7.3 to allow spheroidization (coalescence) of the toner. After about 1.5 to 3 hours, the toner particles possessed the desired circularity of about 0.964 and were quenched to a temperature less than 45° C. using a heat exchanger. Upon cooling, the toners were washed to remove any residual surfactants and/or any residual ions, and dried to a moisture content below 1.2 weight percent.

### Example 3

Optimum Toner Blending Process for Additive Package. A blending process was tested to determine its effects on toner performance. The additive package included seven materials and/or constituents. Specifically, the additive package included the following (all amounts are percent by weight of the toner particles):
1) about 1.28 percent by weight of a silica surface treated with polydimethylsiloxane, such as RY50L available from Evonik (Nippon Aerosil);
2) about 0.86 percent by weight of a silica surface treated with hexamethyldisilazane, such as RX50 available from Evonik (Nippon Aerosil);
3) about 0.73 percent by weight of a sol-gel silica surface treated with hexamethyldisilazane, such as X24-9163A available from Nisshin Chemical Kogyo;
4) about 0.88 percent by weight of a titanium surface treated with butyltrimethoxysiliane, such as STT100H available from Titan Koygo;
5) about 0.28 percent by weight of a cerium dioxide, such as E10 available from Mitsui Mining & Smelting;
6) about 0.18 percent by weight of a zinc stearate, such as ZnFP available from NOF; and
7) about 0.50 percent by weight of PMMA polymer particles, such as MP116CF available from Soken.

It was found that the specific blend power and specific blend energy were important parameters for toner functionality. The factors that controlled these parameters were tool speed and blend time, respectively. An overview of the energy and power found to provide suitable toner properties are summarized in the Table 2 below.

TABLE 2

| | | Specific | | |
|---|---|---|---|---|
| | | Power (W/lb) | | |
| | | 80 | 95 | 110 |
| Specific | 20 | x | x | x |
| Energy | 13.3 | x | x | x |
| (W hr/lb) | 6.7 | x | x | x |

The x in Table 2 means a toner was tested at the Specific Energy and Specific Power.

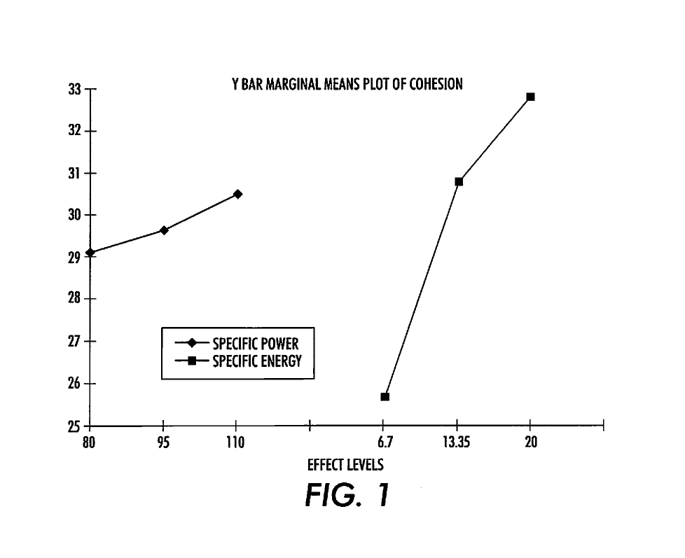

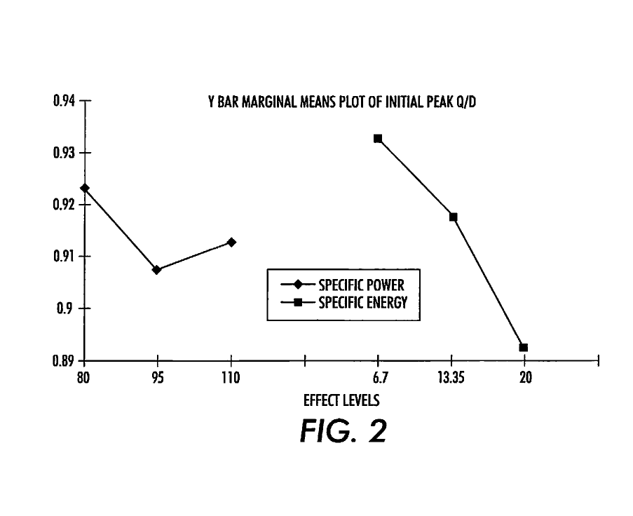

Optimized blend conditions are set forth in Table 2 above. For both lower cohesion and higher initial peak toner charge (q/d), specific energy was found to have a significant effect as shown in FIGS. 1 and 2.

The optimized conditions for the additive package resulted in lower cohesion as well as higher q/d peak position. It was found that desirable conditions for additive blending were:
Specific Blend Power: 80 W/lb
Specific Blend Energy: 13.3 W-hr/lb
Vessel Loading: 0.33 lb toner/L

### Example 4

In addition to the cyan toner described in Example 2, a yellow toner was produced following the procedure of Example 2, using about 6.8 parts of a PY17 pigment; a magenta toner was produced following the procedure of Example 2, using about 10.9 parts of PR122/26 pigments; and a black toner was produced following the procedure of Example 2, using about 8.3 parts of Nipex 35/PB 15:3 pigments.

Additives were added to each of the toners in parts per hundred (pph) relative to the parent toner weight, and were RY50L silica (1.29%), RX50 silica (0.86%), X24 sol-gel silica (0.73%), STT100H titania (0.88%), E10 cerium oxide (0.275%), ZnFP zinc stearate (0.18%), and MP116CF PMMA (0.50%).

The toners were blended with the additives in a 10 liter Henschel blender using 3.3 pounds of toner particles at about 2,640 rpm for about 10 minutes. Additional toners were blended with additives in a 1,200 liter Henschel production blender using about 500 pounds of toner particles at about 865 rpm for about 10 minutes. The toners were sieved using an Alpine Jet sieve apparatus and a 45 μm screen.

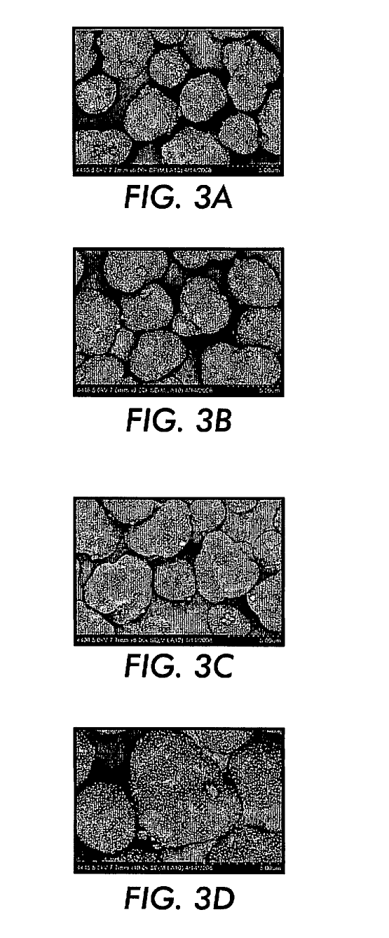

Scanning electron micrograph images of the resulting toners, with additives, were obtained with a Hitachi or Amray field-emission scanning electron microscope. The results are set forth in FIGS. 3A (cyan), 3B (yellow), 3C (magenta), and 3D (black).

Color Evaluation. The toners were tested via a wet deposition test method and color difference (Delta E) was compared to a commercially available EA Eco toner from Fuji Xerox. The color difference was ≦2 Delta E units.

Fusing Evaluation. The toners were tested with a Patriot bench fusing fixture (FBNF) using standard fusing procedures of operating at about 220 mm/second, about 34 millisecond dwell time, as applied to an oil-less, CX+ paper (90 gsm uncoated). The target mass per unit area was about 1 mg/cm². Compared with the EA Eco toner from Fuji Xerox, the toners of the present disclosure:

(1) Had similar gloss curves to the Fuji Xerox toners with a glass transition temperature of from about 136° C. to about 140° C. and a Peak gloss of about 68 Gardner Gloss Units (ggu).

(2) had slightly lower crease fix MFT compared to the toners from Fuji Xerox. The tested toners had an MFT(Crease Area=80) of about 127° C., which was lower than the toner from Fuji Xerox ((MFT(Crease Area=80) of about 132° C.

(3) Had similar hot offset performance with a latitude (Hot offset—MFT) of from about 73° C. to about 84° C. as compared with the fusing latitude of the toner from Fuji Xerox of about 78° C.

Machine Testing. The cyan and yellow toners described above were compared with the toner from Fuji Xerox by running them through a Xerox 700 Digital Color Press machine, in both A-zones and J-zones. Toner Concentration Latitude was evaluated. Similar performance was witnessed for both cyan and yellow toners. The cyan toners of the present disclosure displayed better 100% Density than the toner from Fuji Xerox (the Fuji Xerox toner measured twice at the upper limit of the specification). The results are summarized in Tables 3A-3B and 4A-4B below.

TABLE 3A
Cyan Toner

| Cyan | | | | | | |
|---|---|---|---|---|---|---|
| A Zone Performance | | same additive formulation as Control | | | | lower sol gel |
| Metric | Method | Sample 1 | Sample 2 | Sample 3 | Sample 4 | silica toner |
| Density 100% | densitometer | 1.65 | 1.64 | 1.71 | 1.75 | 1.51 |
| Density 60% | densitometer | 1.17 | 1.1 | 1.26 | 1.25 | 0.93 |
| Density 20% | densitometer | 0.26 | 0.24 | 0.3 | 0.29 | 0.18 |
| L-star | IQAF | 53.24 | 53.49 | 52.94 | 54.47 | 52.7 |
| C-star | IQAF | 60.29 | 60.04 | 60.59 | 59.03 | 60.33 |
| Gloss | 75° | 48.6 | 45.5 | 53.5 | 52.2 | 51.4 |
| | Glossmeter | | | | | |
| Fusing | Crease | 20 | 20 | 20 | 20 | 20 |
| Bkg | Visual | 1 | 1 | 1 | 1 | 1 |
| Bkg deltaE | IQAF | 4.02 | 4.08 | 4.2 | 4.4 | 4.01 |
| Banding unif Lateral | IQAF | 0.63 | 0.55 | 0.44 | 0.53 | 0.52 |
| Direction | | | | | | |
| Banding unif Process | IQAF | 0.66 | 0.61 | 0.57 | 0.59 | 0.66 |
| Direction | | | | | | |
| Mottle | Visual | 2 | 2 | 2 | 2 | 2 |
| Graininess | Visual | 2 | 2 | 2 | 2 | 2 |
| Starvation | Visual | 2 | 2 | 2 | 2 | 2 |
| TC | ROBOT | 8.17 | 7.66 | 7.46 | 8.23 | 7.46 |
| Tribo | ROBOT | 23.73 | 24.23 | 21.04 | 18.29 | 22.07 |
| A(t) | Calc | 288.79 | 282.52 | 241.12 | 223.69 | 252.7 |

L-star = lightness
C-star = Chroma
Bkg = background
Bkg deltaE—background color difference
Banding unif Lateral Direction = banding observed in lateral direction
Banding unif Process Direction = banding observed in process direction
TC = toner concentration
Tribo = triboelectric charge
A(t) = (TC + 4) * Tribo

TABLE 3B

| Cyan | | | | | | |
|---|---|---|---|---|---|---|
| A Zone Performance | | Specs | | | | |
| Metric | Method | cyan | Control | Control | Control | Control |
| Density 100% | densitometer | 1.27-1.77 | 1.64 | 1.77 | 1.75 | 1.77 |
| Density 60% | densitometer | 0.86-1.36 | 1.1 | 1.26 | 1.21 | 1.18 |
| Density 20% | densitometer | 0.11-0.39 | 0.24 | 0.3 | 0.25 | 0.22 |
| L-star | IQAF | n/a | 52.26 | 52.67 | 53.26 | 53.7 |
| C-star | IQAF | n/a | 61.23 | 60.8 | 60.28 | 59.84 |
| Gloss | 75o | 40-60 | 45.5 | 52.7 | 54.9 | 54.1 |
| | Glossmeter | | | | | |
| Fusing | Crease | 80 | 20 | 20 | 20 | 20 |
| Bkg | Visual | ≦G2 | 1 | 1 | 1 | 1 |
| Bkg deltaE | IQAF | n/a | 3.67 | 3.85 | 4.14 | 4.24 |
| Banding unif Lateral | IQAF | n/a | 0.58 | 0.68 | 0.5 | 0.5 |
| Direction | | | | | | |
| Banding unif Process | IQAF | n/a | 0.72 | 0.62 | 0.65 | 0.54 |
| Direction | | | | | | |
| Mottle | Visual | ≦G4 | 2 | 2 | 2 | 2 |
| Graininess | Visual | ≦G3 | 2 | 2 | 2 | 2 |
| Starvation | Visual | ≦G3 | 2 | 2 | 2 | 2 |
| TC | ROBOT | tbd | 7.79 | 7.7 | 7.89 | 7.52 |
| Tribo | ROBOT | tbd | 23.39 | 21.42 | 21.73 | 20.69 |
| A(t) | Calc | tbd | 275.77 | 250.61 | 258.37 | 238.35 |

TABLE 4A

| Yellow | | same additive | | | |
|---|---|---|---|---|---|
| A Zone Performance | | formulation as Control | | lower sol gel | |
| Metric | Method | Sample 5 | Sample 6 | silica toner | yellow |
| Density 100% | densitometer | 1.5 | 1.48 | 1.44 | 1.32-1.82 |
| Density 60% | densitometer | 1.19 | 1.23 | 1.1 | 0.9-1.4 |
| Density 20% | densitometer | 0.31 | 0.28 | 0.22 | 0.1-0.38 |
| L-star | IQAF | 89.31 | 89.37 | 89.26 | n/a |
| C-star | IQAF | 94.04 | 91.83 | 90.78 | n/a |
| Gloss | 75° | 54.3 | 52 | 52.6 | 40-60 |
| | Glossmeter | | | | |
| Fusing | Crease | 20 | 20 | 20 | 80 |
| Bkg | Visual | 1 | 1 | 1.7 | ≦G2 |
| Bkg deltaE | IQAF | 3.85 | 3.69 | 3.9 | n/a |
| Banding unif Lateral | IQAF | 0.68 | 0.63 | 0.58 | n/a |
| Direction | | | | | |
| Banding unif Process | IQAF | 0.62 | 0.75 | 0.61 | n/a |
| Direction | | | | | |
| Mottle | Visual | 2 | 2 | 2 | ≦G4 |
| Graininess | Visual | 2 | 2 | 2 | ≦G3 |
| Starvation | Visual | 0 | 0 | 0 | ≦G3 |
| TC | ROBOT | 7.17 | | 8.22 | tbd |
| Tribo | ROBOT | 25.46 | | 24.03 | tbd |
| A(t) | Calc | 284.39 | | 293.50 | tbd |

TABLE 4B

| Yellow | | | | | | | |
|---|---|---|---|---|---|---|---|
| A Zone | | | | | | | |
| Performance | | | | | | | |
| Metric | Method | Control | Control | Control | Control | Control | Control |
| Density 100% | densitometer | 1.5 | 1.48 | 1.48 | 1.55 | 1.55 | 1.55 |
| Density 60% | densitometer | 1.17 | 1.2 | 1.24 | 1.26 | 1.26 | 1.26 |
| Density 20% | densitometer | 0.26 | 0.28 | 0.34 | 0.31 | 0.31 | 0.31 |
| L-star | IQAF | 89.3 | 89.26 | 89.3 | 89.39 | 89.39 | 89.39 |
| C-star | IQAF | 94.36 | 97.03 | 94.41 | 90.91 | 90.91 | 90.91 |
| Gloss | 75° | 50.3 | 49.6 | 55.1 | 50.8 | 50.8 | 50.8 |
| | Glossmeter | | | | | | |
| Fusing | Crease | 20 | 20 | 20 | 20 | 20 | 20 |
| Bkg | Visual | 1 | 1 | 1 | 1 | 1 | 1 |
| Bkg deltaE | IQAF | 4.02 | 4.08 | 4.2 | 4.4 | 4.4 | 4.4 |
| Banding unif | IQAF | 0.63 | 0.55 | 0.44 | 0.53 | 0.53 | 0.53 |
| Lateral Direction | | | | | | | |
| Banding unif | IQAF | 0.66 | 0.61 | 0.57 | 0.59 | 0.59 | 0.59 |
| Process Direction | | | | | | | |
| Mottle | Visual | 2 | 2 | 2 | 2 | 2 | 2 |
| Graininess | Visual | 2 | 2 | 2 | 2 | 2 | 2 |
| Starvation | Visual | 0 | 0 | 0 | 0 | 0 | 0 |
| TC | ROBOT | 7.61 | 7.37 | 7.13 | 7.74 | 7.74 | 7.74 |
| Tribo | ROBOT | 25.24 | 24.22 | 23.4 | 21.08 | 21.08 | 21.08 |
| A(t) | Calc | 293.04 | 275.38 | 260.44 | 247.48 | 247.48 | 247.48 |

Aging Test Summary. Comparable results were found among toners of the present disclosure and the toner from Fuji Xerox. Similar charging characteristics were found for all toners. The toners had a similar q/d peak, but toners from Fuji Xerox showed widening q/d distribution with age. Background was moderate for all toners.

Carrier bead carry-out (BCO) was negligible for all toners. Development voltage was stable. All toners showed good image quality throughout the aging test. Similar transfer efficiencies (T.E.) were observed for all toners, with the toners of the present disclosure averaging 78% T.E., and the toner from Fuji Xerox averaging 75% T.E.

Tc Latitude (TCL) Test Summary. Overall, similar results were observed for the toners. Very similar toner charge per mass ratio (Q/m). Toner charge multiplied by toner concentration (At) for toners of the present disclosure was slightly more stable. Lower q/d (and consequent narrower charge distribution width) for toners of the present disclosure. Similar onset of wrong sign toner (at approximately 11% TC). Onset of high background, at cleaning fields close to nominal (−50 Vclean showed very high background) set-point for both toners. BCO was negligible for all toners. Similar Transfer efficiencies: toners of the present disclosure averaged 77% T.E., the toner from Fuji Xerox averaged 75% T.E.

Failure Mode Testing Summary. Overall, fairly similar results among the materials in Aerosol Clouding, Automatic Toner Concentration (ATC) Sensor Response, Developer Clogging, Trim-bar Clogging, as well as in Color delta E.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A toner comprising:
toner particles comprising at least one amorphous resin in combination with at least one crystalline resin, an optional colorant, and an optional wax; and
a surface additive package comprising:
a polydimethylsiloxane surface treated silica present in an amount of from about 1.15% by weight to about 1.4% by weight of the toner particles;
a silazane surface treated silica present in an amount of from about 0.75% by weight to about 0.95%% by weight of the toner particles;
a silazane surface treated sol-gel silica present in an amount of from about 0.45% by weight to about 1.5% % by weight of the toner particles;
a titania surface treated with a material selected from the group consisting of decylsilane, decyltrimethoxysilane and butyltrimethoxysilane present in an amount of from about 0.2% by weight to about 1.0% by weight of the toner particles;
a metal oxide selected from the group consisting of cerium oxide, tin oxide, and combinations thereof, present in an amount of from about 02% by weight to about 0.35% by weight of the toner particles;
zinc stearate present in an amount of from about 0.15% by weight to about 0.25% by weight of the toner particles; and
a polymethyl methacrylate present in an amount of from about from about 0.4% by weight to about 0.6% by weight of the toner particles.

2. The toner of claim 1, wherein the amorphous resin is of the formula: 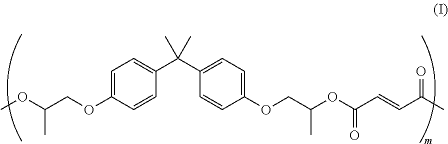
wherein m may be from about 5 to about 1000, and the crystalline resin is of the formula: 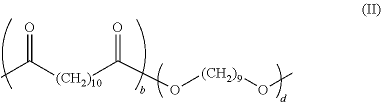
wherein b is from about 5 to about 2000 and d is from about 5 to about 2000.

3. The toner of claim 1, wherein the amorphous resin comprises a high molecular weight amorphous resin having a molecular weight of from about 35,000 to about 150,000 in combination with a low molecular weight amorphous resin having a molecular weight of from about 10,000 to about 35,000.

4. The toner of claim 3, wherein the ratio of high molecular weight amorphous resin to low molecular weight amorphous resin to crystalline resin is from about 6:6:1 to about 5:5:1.

5. The toner of claim 1, wherein the polydimethylsiloxane surface treated silica is present in an amount of from about 0.5% by weight to about 2.5% by weight of the toner particles, the silazane surface treated silica is present in an amount of from about 0.3% by weight to about 2.0%% by weight of the toner particles, the silazane surface treated sol-gel silica is present in an amount of from about 0.2% by weight to about 3.0% % by weight of the toner particles, the titania comprises titania surface treated with butyltrimethoxysilane and is present in an amount of from about 0.2% by weight to about 1.2% by weight of the toner particles, the metal oxide comprises cerium oxide present in an amount of from about 0.1% by weight to about 1.0% by weight of the toner particles, the zinc stearate is present in an amount of from about 0.05% by weight to about 1.0% by weight of the toner particles, and the polymethyl methacrylate is present in an amount of from about from about 0.1% by weight to about 1.5% by weight of the toner particles.

6. The toner of claim 1, wherein the toner has a triboelectric charge of from about final triboelectric charge of from −4 μC/g to about −50 μC/g.

7. The toner of claim 1, wherein the toner has a gloss of from about 30 ggu to about 80 ggu.

8. A toner comprising:
toner particles comprising at least one high molecular weight amorphous resin having a molecular weight of from about 35,000 to about 150,000, in combination with a low molecular weight amorphous resin having a molecular weight of from about 10,000 to about 35,000, in combination with at least one crystalline resin, an optional colorant, and an optional wax; and
a surface additive package comprising:
a polydimethylsiloxane surface treated silica present in an amount of from about 1.15% by weight to about 1.4% by weight of the toner particles;
a silazane surface treated silica present in an amount of from about 0.75% by weight to about 0.95% by weight of the toner particles;
a silazane surface treated sol-gel silica present in an amount of from about 0.45% by weight to about 3.0% by weight of the toner particles;
a titania surface treated with a material selected from the group consisting of decylsilane, decyltrimethoxysilane and butyltrimethoxysilane present in an amount of from about 0.2% by weight to about 1.2% by weight of the toner particles;
a metal oxide selected from the group consisting of cerium oxide, tin oxide, and combinations thereof, present in an amount of from about 0.2% by weight to about 0.35% by weight of the toner particles;
zinc stearate present in an amount of from about 0.15% by weight to about 0.25% by weight of the toner particles; and
a polymethyl methacrylate present in an amount of from about from about 0.4% by weight to about 0.6% by weight of the toner particles.

9. The toner of claim 8, wherein the high molecular weight amorphous resin, the low molecular weight amorphous resin, or both, is of the formula: 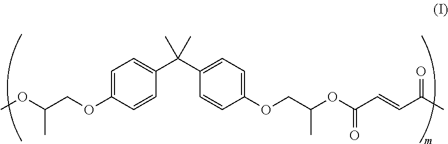
wherein m may be from about 5 to about 1000, and the crystalline resin is of the formula: 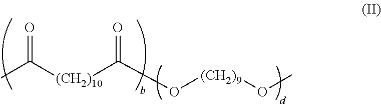
wherein b is from about 5 to about 2000 and d is from about 5 to about 2000.

10. The toner of claim 8, wherein the ratio of high molecular weight amorphous resin to low molecular weight amorphous resin to crystalline resin is from about 6:6:1 to about 5:5:1.

11. The toner of claim 8, wherein the polydimethylsiloxane surface treated silica is present in an amount of from about 0.5% by weight to about 2.5% by weight of the toner particles, the silazane surface treated silica is present in an amount of from about 0.3% by weight to about 2.0%% by weight of the toner particles, the silazane surface treated sol-gel silica is present in an amount of from about 0.2% by weight to about 3.0% % by weight of the toner particles, the titania comprises titania surface treated with butyltrimethoxysilane and is present in an amount of from about 0.1% by weight to about 2.0% by weight of the toner particles, the metal oxide comprises cerium oxide present in an amount of from about 0.1% by weight to about 1.0% by weight of the toner particles, the zinc stearate is present in an amount of from about 0.05% by weight to about 1.0% by weight of the toner particles, and the polymethyl methacrylate is present in an amount of from about from about 0.1% by weight to about 1.5% by weight of the toner particles.

12. The toner of claim 8, wherein the toner has a triboelectric charge of from about final triboelectric charge of from −4 μC/g to about −50 μC/g.

13. The toner of claim 8, wherein the toner has a gloss of from about 30 ggu to about 80 ggu.

14. A method comprising:
contacting toner particles with an additive package comprising:
a polydimethylsiloxane surface treated silica present in an amount of from about 1.15% by weight to about 1.4% by weight of the toner particles;
a silazane surface treated silica present in an amount of from about 0.75% by weight to about 0.95%% by weight of the toner particles;
a silazane surface treated sol-gel silica present in an amount of from about 0.45% by weight to about 3.0% % by weight of the toner particles;
a titania surface treated with a material selected from the group consisting of decylsilane, decyltrimethoxysilane and butyltrimethoxysilane present in an amount of from about 0.2% by weight to about 1.2% by weight of the toner particles;
a metal oxide selected from the group consisting of cerium oxide, tin oxide, and combinations thereof, present in an amount of from about 0.2% by weight to about 0.35% by weight of the toner particles;
zinc stearate present in an amount of from about 0.15% by weight to about 0.25% by weight of the toner particles; and
a polymethyl methacrylate present in an amount of from about from about 0.4% by weight to about 0.6% by weight of the toner particles; and
blending the toner particles with the additive package at a rate of from about 500 revolutions per minute to about 2000 revolutions per minute, for a period of time of from about 2 to about 20 minutes.

15. The method of claim 14, wherein blending the toner particles and additive package utilizes a specific power of from about 60 watts per pound of toner and additives to about 100 watts per pound of toner and additives.

16. The method of claim 14, wherein blending the toner particles and additive package applies a specific energy from about 6.7 watt hours per pound of toner and additives to about 20 watt hours per pound of toner and additives.

17. The method of claim 14, wherein the amorphous resin is of the formula: 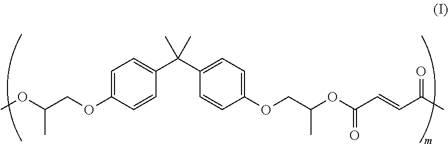
wherein m may be from about 5 to about 1000, and the crystalline resin is of the formula: 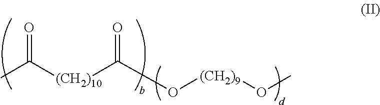
wherein b is from about 5 to about 2000 and d is from about 5 to about 2000.

18. The method of claim 14, wherein the amorphous resin comprises a high molecular weight amorphous resin having a molecular weight of from about 35,000 to about 150,000 in combination with a low molecular weight amorphous resin having a molecular weight of from about 10,000 to about 35,000.

19. The method of claim 14, wherein the ratio of high molecular weight amorphous resin to low molecular weight amorphous resin to crystalline resin is from about 6:6:1 to about 5:5:1.

20. The method of claim 14, wherein the toner has a triboelectric charge of from about final triboelectric charge of from −4 μC/g to about −50 μC/g.
